(19) United States
(12) Patent Application Publication
(10) Pub. No.: US 2017/0347187 A1
(43) Pub. Date: Nov. 30, 2017

(54) ACOUSTIC FOCUSING APPARATUS

(71) Applicant: Richard Haberkern, Burbank, CA (US)

(72) Inventor: Richard Haberkern, Burbank, CA (US)

(21) Appl. No.: 15/163,008

(22) Filed: May 24, 2016

(51) Int. Cl. H04R 1/34; H04R 1/40; H04R 1/02; H04R 3/12

(52) U.S. Cl. CPC H04R 1/345; H04R 3/12; H04R 1/403; H04R 1/028; H04R 2201/401; H04R 2201/403

(57) ABSTRACT

An acoustic focusing apparatus helps focus sound waves to target a predictable region. The predictable region may include the ears of a user. The acoustic focusing apparatus provides a plurality of transducers arranged in a planar array; whereas the transducers are on the same plane and mounted along parallel rows. The apparatus further provides a plurality of wave guides extending from a wave output surface on the transducers to focus the sound waves towards the predictable region. The apparatus utilizes at least one reflective portion that reflects the sound waves emitting from the wave guides towards the predictable region, and also helps diffuse and mask the source of the sound waves. In this manner, the apparatus focuses an audio signal directly at a person's ears so as to produce private, high fidelity stereo sound without use of headphones, while simultaneously not disturbing others within the same environment.

### CROSS- REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to an acoustic focusing apparatus. More particularly, certain embodiments of the invention relates to an acoustic focusing apparatus that focuses sound waves at a target predictable region through the arrangement of a plurality of transducers in a planar array and in a straight line, and provides a plurality of wave guides to focus the sound waves leaving the transducers, and at least one reflective portion to reflect the guided sound waves towards the target predictable surface and also to diffuse and mask the source of the sound waves.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that speakers are used to convert electrical signals to acoustic signals, and thereby amplify sound. One type of speaker is a transducer.

Typically, a transducer is a device that converts one form of energy to another type of energy, such as sound. Usually a transducer converts a signal in one form of energy to a signal in another. A speaker is a device containing one or more electroacoustic transducers. The speaker converts an electrical audio signal into a corresponding sound. Specifically, audio speakers are used to produce sound such as music or voice that one or more listeners are able to hear. In conjunction with speakers, headphones or earphones are used to produce audio that only one listener is able to hear. It is known in the art that low distortion and thus high fidelity reproduction is achieved because of the very small volume of air that must be driven.

In many instances, a waveguide is a structure that guides waves, such as electromagnetic waves or sound waves. They enable a signal to propagate with minimal loss of energy by restricting expansion to one dimension or two. It is known that an acoustic mirror that can take multiple shapes is a passive device used to reflect and perhaps to focus sound waves. Often, focusing the sound waves involves increasing the intensity or volume over a large area.

It is known that high fidelity directional audio is used to enable a single individual or small group of people in crowded environments such as homes, offices, public spaces, museums and other areas with competing sound information. This can be accomplished with parametric speakers that produce directional audio by creating modulated sound waves in the ultrasonic range. Speakers encased within a dome shape reflector are another common type of listening device for one person.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a diagram of an exemplary acoustic focusing apparatus, in accordance with an embodiment of the present invention;

FIGS. 2A and 2B illustrate diagrams of an exemplary acoustic focusing apparatus having at least one wave reflection portion, where FIG. 2A illustrates an exemplary dual flat reflector, and FIG. 2B illustrates an exemplary flat reflector, in accordance with an embodiment of the present invention;

FIG. 3 illustrates a diagram of an exemplary acoustic focusing apparatus generating low distortion and stable audio that is focused towards an exemplary targeted predictable region, in accordance with an embodiment of the present invention; and

FIG. 4 illustrates a diagram of an exemplary acoustic focusing apparatus having an exemplary plurality of transducers and wave guides isolated and a laminar audio wave front, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings. There are various types of acoustic manipulation devices that may be provided by preferred embodiments of the present invention.

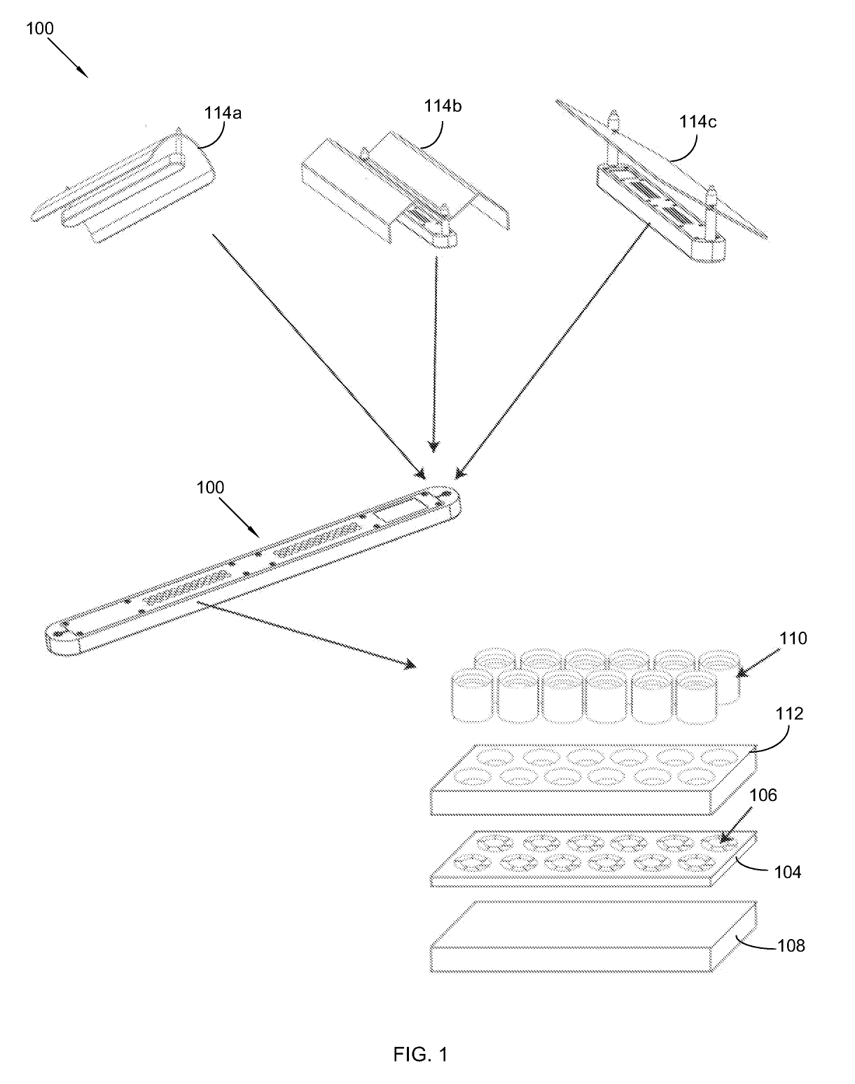

FIG. 1 illustrates a diagram of an exemplary acoustic focusing apparatus 100 that may be configured to help focus sound waves towards a target predictable region in a way that provides sound waves having a low pressure, a narrow range, and a short distance. In one embodiment, the predictable region may include the ears of a user.

In some embodiments, the acoustic focusing apparatus may focus the sound waves through a plurality of transducers 104 that are arranged in a generally planar, linear array; whereas the transducers are on the same plane and mounted along parallel rows. It is the arrangement of the transducers along the same plane that enables a substantial amount of the sound wave focusing function to be achieved, as described below. The transducers convert audio electrical signals into a plurality of sound waves, which are then directionally emitted. The transducers may include a wave output surface from which the sound waves emit at a perpendicular disposition therefrom.

In some embodiments, the apparatus may further comprise a plurality of wave guides 110. The wave guides may be configured to extend from the wave output surface on the transducers. The wave guides may further be configured to focus the sound waves towards a target predictable region. Those skilled in the art will recognize that, the planar, linear arrangement of the transducers may make the sound waves louder at distances. Through use of the wave guides, the apparatus may keep the sound waves isolated from each transducer and then later focus the sound waves with minimal increase in sound pressure levels at the target predictable region, i.e., listening area.

Further, the apparatus may utilize at least one reflective portion 114a, 114b, 114c that reflects the sound waves emitting from the wave guides. The reflective portion may at least partially reflect the sound waves towards the predictable region. Further, the reflective portion may also to help diffuse and mask the source of the sound waves. In this manner, the apparatus may focus an audio signal directly at a person's ears without the need for headphones, large spherical domes, or the emission of inaudible ultrasonic energy.

In one embodiment, there may be multiple transducers in an individual array. Further, there can be one or more arrays comprised of a plurality of transducers each with its own discrete audio channel. As defined for the present apparatus, an audio channel may include an audio signal communications channel in a storage device, such as that used in operations for multi-track recording and sound reinforcement.

In one exemplary embodiment, the transducers comprise a plurality of small sound sources that are representative for each audio channel. Each audio channel may contain unique audio information (sound). Music, voice, ambient sound, etc. Further, there can be one or more discrete audio channels up to an unlimited number. Left/right audio channels would be two channels for stereo. More audio channels can be used with a potential for any number of discrete audio channels.

In one exemplary embodiment, the transducers emit low pressure output of sound waves from the same plane. Each transducer produces an isolated sound wave that is focused to a known point in air where the sound waves are guided and reflected to combine. The combined sound waves may increase the volume or audible sound pressure levels slightly. This slight but focused sound pressure level is usually within the sound pressure range of normal speech. Specifically, the apparatus produces low pressure levels of the sound waves with high fidelity audio over a short range of only a few feet through the air.

Thus in one exemplary use, the apparatus produces private, high fidelity stereo sound without the use of headphones, while simultaneously not disturbing other people within the same environment, and without requiring the listener to be encased in a separate room or within partitions.

As FIG. 1 illustrates, the acoustic focusing apparatus. The apparatus comprises a plurality of transducers. In some embodiments, the transducers may be configured to convert acoustic electrical signals into sound waves. The transducers may comprise a wave output surface 106 from which the sound waves are emitted at a generally perpendicular disposition. The plurality of transducers may include, without limitation, a standard audio speaker, a tweeter, a woofer, an electrostatic film, a piezo-electric element, and a system that produces sound waves.

In one embodiment, the transducers may be arranged in a generally linear array. Further, the planar array arrangement of transducers is disposed in a linear arrangement whereas its length is substantially longer than its width. In one embodiment, this may include multiple acoustic drivers or speakers mounted on the same physical plane, and along parallel rows. The use of planar array arrangement of transducers eliminates the need for any type of acoustically reflective or absorbing materials along a narrow ends. The planar array arrangement causes the sound waves to be maintained in a focused direction.

In one embodiment, the apparatus may include a sound dampening portion 108 for absorbing back waves generated by the transducers. The sound dampening portion may at least partially surround, contain, or encapsulate the transducers. In some embodiments, and for ease of manufacturing, multiple transducers may be mounted to the same speaker membrane or surface.

In some embodiments, the apparatus may include a plurality of wave guides that correspond to a respective transducer. The wave guides may join with the wave output surface of the transducer. In one embodiment, the wave guides may be constructed as a mechanical tube that extends above each transducer. Though in other embodiments, the wave guides may include a tube, a duct, or any other structure that uses air and a rigid medium to isolate each transducer from adjacent transducers and maintain a combined low distortion audio laminar wave front.

The transducers and the wave guides may be combined into a wave emitting and focusing assembly 102 that generates and focuses sound waves in a desired direction and intensity. The wave emitting and focusing assembly may have a generally rectangular shape that is portable and adjustable. Though in other embodiments, the emitting and focusing assembly may have different shapes.

In one embodiment, a wave guide alignment assembly 112 helps to maintain the wave guides in the desired orientation relative to the wave output surface of the transducer. The wave guide alignment assembly may include a rectangular box having a plurality of apertures sized and dimensioned to receive individual wave guides.

The wave guides associated with a given transducer segregates the transducers, and their sound waves. In this manner, the sound waves are isolated in a unique channel until combined at the target predictable region. In one example, the isolated sound waves create a laminar rectangular wave front that are then directed onto an acoustically reflective wave reflection portion where the sound waves are redirected and focused to combine in a target predictable region, such as a listener's ears.

The wave guides are employed to direct the generated sound waves towards at least one wave reflection portion. The wave reflection portion is adjustable and reflects the sound waves in a desired direction. In one embodiment, the wave guides help focus the sound waves below a surface of the wave reflection portion. Because of the planar, linear disposition of the transducers and wave guides, the wave reflection portion may be defined by a reflective surface having any shape, including, without limitation, a curved reflector 114a, a flat reflector 114c, and a dual flat reflector 114b. Though in other embodiments, the wave reflection portion may include complex shapes that can be employed to focus different transducers to different points in space. In another embodiment, the wave reflection portion may include an acoustic mirror.

In one operational use, the reflected sound waves bouncing off the wave reflection portion combine in a focused beam at a target predictable region. The target predictable region may include, without limitation, an ear of a listener, a headphone speaker, and a microphone. The sound waves may be focused towards the target predictable region such that only the target predictable region produces the loudest, stable audio image with low distortion and high fidelity. This may include a region where a listener's ears are located. However, regions outside of the target predictable region may have a measurable and significantly lower audio output level with much less audio fidelity. In this manner, only the listener can hear a substantial portion of the sound waves, and other potential listeners are substantially excluded from hearing the focused sound waves.

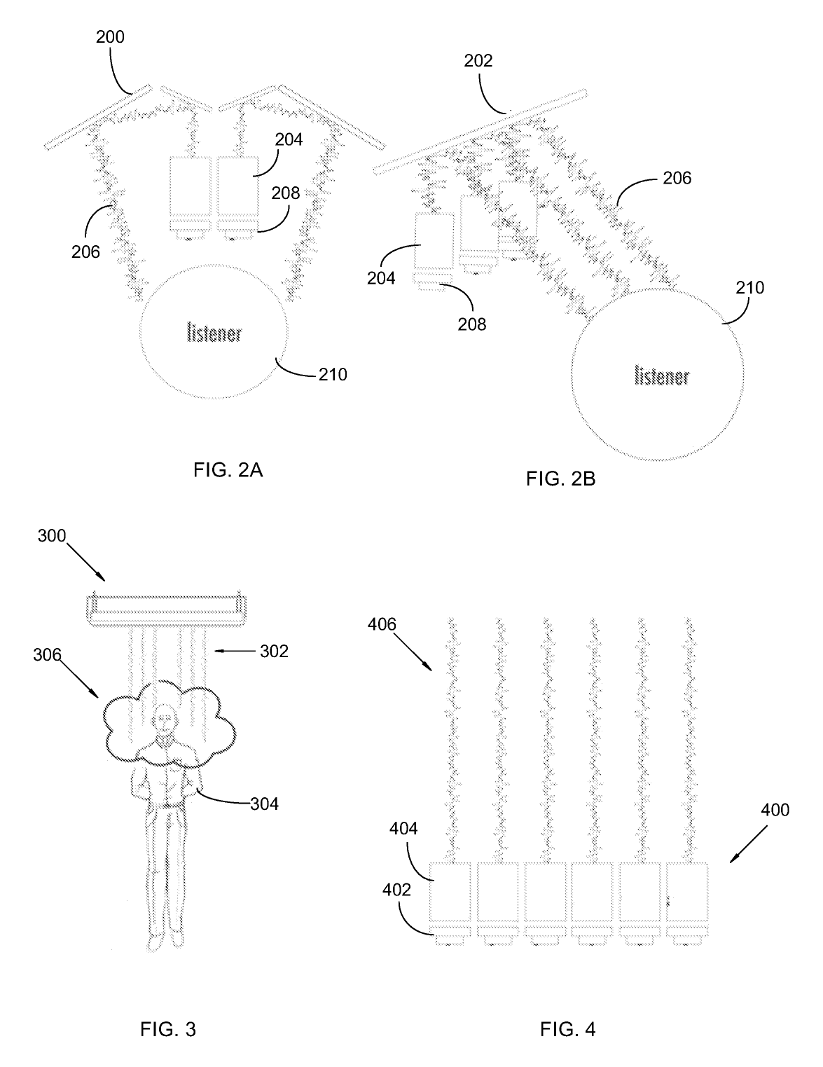

FIGS. 2A and 2B illustrate diagrams of an exemplary acoustic focusing apparatus having at least one wave reflection portion, where FIG. 2A illustrates an exemplary dual flat reflector 200, and FIG. 2B illustrates an exemplary flat reflector 202. In one aspect, the wave reflection portion serves to focus a plurality of sound waves 206 emitted from a plurality of transducers 208 and guided by a plurality of wave guides 204. The wave reflection portion may be adjusted to accommodate the desired direction for the sound waves arriving from the planar array arrangement of the transducers and joined wave guides. In the present example, the target predictable region is an ear for a listener 210.

Those skilled in the art will recognize that the need for a closed dome or ellipsoidal shape for the wave reflection portion is negated because of the planar, linear arrangement of the transducers and wave guides. The wave reflection portion may also be physically linear in design with its length considerably longer than its width, much like a florescent lighting enclosure making it easy to install in most, if not all, environments. The ends of the wave reflection portion may be open without the need to contain or focus any stray sound waves.

As FIG. 2A illustrates, one wave reflection portion may be used in the form of a dual flat reflector. As FIG. 2B shows, two wave reflection portions may be used in the form of a dual flat reflector. It is significant o note that because the sound waves are arriving from a planar arrangement, the wave reflection portion may take any number of shapes conducive to reflecting the sound waves to the desired region. In other embodiments, the wave reflection portion may also serve as a diffuser to mask the apparent source of the sound waves (transducers) from the target predictable region (listener) standing in the path of the sound waves.

FIG. 3 illustrates a diagram of an exemplary acoustic focusing apparatus 300 generating low distortion and stable audio signal 302 that is focused towards an exemplary targeted predictable region 304. In one aspect, the combination of the transducers and the accompanying wave guides produces a low distortion sound field 306 that is perpendicular to each driver's surface. Each sound field is isolated from adjacent sound waves so that the waves do not combine in the air. It is significant to note that further acoustic control of the sound waves towards the target predictable region may be obtained by coordinated and independent signal processing of each apparatus in an array or group of apparatuses.

FIG. 4 illustrates a diagram of an exemplary acoustic focusing apparatus 400 having an exemplary plurality of transducers 402 and wave guides 404 isolated and a laminar audio wave front 406. In one aspect, the wave guides may include a tube, a duct, or any other structure that uses air and a rigid medium to isolate each transducer from adjacent transducers and maintain a combined low distortion audio laminar wave front. The planar, straight line arrangement of the transducers allows for this unique configuration. In any case, the apparatus produces low pressure levels of the sound waves with high fidelity audio over a short range of only a few feet through the air.

In one exemplary use of the apparatus, stereo sound can be produced by isolating two separate sets of transducers in planar arrays or audio channels to form left and right audio signals. In another embodiment, complex digital signal processing including equalization, phase shifting, delay or any number of other methods can also be used to reproduce stereophonic sound within a single array of transducers. In yet another embodiment, each individual transducer can contain a separate audio amplifier or one or more transducers can be driven by the same audio source.

In another preferred embodiment, multiple apparatuses may be operatively joined to form a single speaker with a length longer than an individual apparatus. In another embodiment, phase shifting, delays and other digital signal processes can be used to improve directionality and further reduce the disturbing of other apparatuses within the same environment. Phase shifting and other digital processing techniques may also be used to produce two or more discreet audio channels within the same planar array area. In another embodiment, the apparatus comprises an illumination portion (not shown). The illumination portion may include a light emitting diode (LED) or any other lighting source can also be bounced off of the wave reflection portion so that the apparatus is both a directional speaker and lighting system.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing an acoustic focusing apparatus that provides transducers arranged in a linear, planar configuration to emit sound waves that are guided and reflected towards a target predictable region according to the present invention will be apparent to those skilled in the art. Various aspects of the invention have been described above by way of illustration, and the specific embodiments disclosed are not intended to limit the invention to the particular forms disclosed. The particular implementation of the acoustic focusing apparatus that provides transducers arranged in a linear, planar configuration to emit sound waves that are guided and reflected towards a target predictable region may vary depending upon the particular context or application. By way of example, and not limitation, the acoustic focusing apparatus that provides transducers arranged in a linear, planar configuration to emit sound waves that are guided and reflected towards a target predictable region described in the foregoing were principally directed to an acoustic focusing apparatus that focuses sound waves towards the ears of a listener through the arrangement of a plurality of transducers in a planar array and in parallel rows, and provides a plurality of wave guides to focus the sound waves leaving the transducers, and at least one reflective portion to reflect the guided sound waves towards the target predictable surface and also to diffuse and mask the source of the sound waves implementations; however, similar techniques may instead be applied to, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. An apparatus comprising:
a plurality of transducers, said plurality of transducers being disposed in a generally planar, linear arrangement, said plurality of transducers being configured to generate a plurality of sound waves, said plurality of transducers further being configured to transmit said plurality of sound waves;
a plurality of wave guides, said plurality of wave guides being configured to join with said plurality of transducers, said plurality of wave guides further being configured to help guide said plurality of sound waves, said plurality of wave guides further being configured to segregate said plurality of sound waves for each transducer; and
at least one reflective portion, said at least one reflective portion being configured to at least partially reflect said guided sound waves from said plurality of wave guides towards a target predictable region, said at least one reflective portion further being configured to at least partially conceal the guided path of the plurality of sound waves,
wherein said generally parallel, linear arrangement of said plurality of transducers enables said at least one reflective portion to have multiple shapes, sizes, and dimensions,
wherein said generally parallel, linear arrangement of said plurality of transducers enables said plurality of sound waves to be focused towards said target predictable region in a discrete audio channel having at least one of the following:
a low pressure, a range, and a short distance.

2. The apparatus of claim 1, in which said plurality of transducers includes at least one member selected from the group consisting of: a speaker, a tweeter, a woofer, an electrostatic film, a piezo-electric element, and a system that produces the plurality of sound waves.

3. The apparatus of claim 2, in which said plurality of transducers comprises a wave output surface.

4. The apparatus of claim 3, wherein said generally planar, linear arrangement of said plurality of transducers comprises the plurality of transducers arranged on the same physical plane in parallel rows.

5. The apparatus of claim 4, wherein said parallel rows comprise a length that is substantially longer than a width.

6. The apparatus of claim 5, wherein said plurality of transducers comprise a generally circular shape.

7. The apparatus of claim 6, wherein said plurality of transducers are configured to phase shift, delay, and perform digital signal processes.

8. The apparatus of claim 7, further including a sound dampening portion.

9. The apparatus of claim 8, wherein said sound dampening portion is configured to help dampen a back sound wave emitted by said plurality of transducers.

10. The apparatus of claim 9, in which said plurality of wave guides comprises a generally tubular shape.

11. The apparatus of claim 10, wherein said plurality of wave guides are directionally adjustable.

12. The apparatus of claim 11, further including a wave guide alignment assembly.

13. The apparatus of claim 12, wherein said wave guide alignment assembly is configured to directionally retain said plurality of wave guides.

14. The apparatus of claim 13, wherein said plurality of transducers joined with said plurality of wave guides comprise a wave emitting and focusing assembly.

15. The apparatus of claim 14, in which said at least one wave reflection portion includes at least one member selected from the group consisting of: a curved reflector, a flat reflector, and a dual flat reflector.

16. The apparatus of claim 15, further including an illumination portion.

17. The apparatus of claim 16, wherein said illumination portion is configured to emit a light at least partially towards said at least one wave reflection portion.

18. The apparatus of claim 17, in which said target predictable region comprises an ear.

19. An apparatus comprising:
means for emitting a plurality of sound waves;
means for guiding said emitting means;
means for reflecting said guided emitting means;
means for receiving said reflected means; and
means for focusing said received means.

20. An apparatus consisting of:
a plurality of transducers, said plurality of transducers being disposed in a generally planar, linear arrangement, said plurality of transducers being configured to generate a plurality of sound waves, said plurality of transducers further being configured to transmit said plurality of sound waves;
a sound dampening portion, said sound dampening portion being configured to help dampen a back sound wave emitted by said plurality of transducers;
a plurality of wave guides, said plurality of wave guides being configured to join with said plurality of transducers, said plurality of wave guides further being configured to help guide said plurality of sound waves, said plurality of wave guides further being configured to segregate said plurality of sound waves for each transducer;
a wave guide alignment assembly, said wave guide alignment assembly being configured to directionally retain said plurality of wave guides;
at least one reflective portion, said at least one reflective portion being configured to at least partially reflect said guided sound waves from said plurality of wave guides towards a target predictable region, said at least one reflective portion further being configured to at least partially conceal the guided path of the plurality of sound waves, said at least one reflective portion including at least one of the following: a curved reflector, a flat reflector, and a dual flat reflector, wherein said generally parallel, linear arrangement of said plurality of transducers enables said at least one reflective portion to have multiple shapes, sizes, and dimensions,
wherein said generally parallel, linear arrangement of said plurality of transducers enables said plurality of sound waves to be focused towards said target predictable region in a discrete audio channel having at least one of the following:
a low pressure, a narrowrange, and a short distance; and
an illumination portion, said illumination portion being configured to emit a light at least partially towards said at least one wave reflection portion.
